(19) United States
(12) Patent Application Publication
(10) Pub. No.: US 2025/0190865 A1
(43) Pub. Date: Jun. 12, 2025

(54) DECENTRALIZED FEDERATED LEARNING USING A RANDOM WALK OVER A COMMUNICATION GRAPH

(71) Applicant: QUALCOMM Incorporated, San Diego, CA (US)

(72) Inventors: Christos LOUIZOS, Amsterdam (NL); Aleksei TRIASTCYN, San Diego, CA (US)

(21) Appl. No.: 18/847,199

(22) PCT Filed: May 17, 2023
(86) PCT No.: PCT/US2023/067115

§ 371 Date: Sep. 13, 2024

(30) Foreign Application Priority Data
May 17, 2022 (GR) 20220100404

(51) Int. Cl. G06N 20/00

(52) U.S. Cl. CPC G06N 20/00

(57) ABSTRACT

Certain aspects of the present disclosure provide techniques and apparatus for training a machine learning model. An example method generally includes receiving, at a device, optimization parameters, parameters of a machine learning model, and optimization state values to be updated based on a local data set. Parameters of the machine learning model and the optimization state values for the optimization parameters are updated based on the local data set. A peer device is selected to refine the machine learning model based on a graph data object comprising connections between the device and a plurality of peer devices, including the peer device. The updated parameters and the updated optimization state values are sent to the selected peer device for refinement by the selected peer device.

### CROSS-REFERENCE TO RELATED APPLICATIONS

This application claims priority to Greece Patent Application Serial No. 20220100404, entitled “Decentralized Federated Learning Using a Random Walk Over a Communication Graph,” filed May 17, 2022, and assigned to the assignee hereof, the entire contents of which are hereby incorporated by reference.

### INTRODUCTION

Aspects of the present disclosure relate to machine learning.

Federated learning generally refers to various techniques that allow for training a machine learning model to be distributed across a plurality of client devices, which beneficially allows for a machine learning model to be trained using a wide variety of data. For example, using federated learning to train machine learning models for facial recognition may allow for these machine learning models to train from a wide range of data sets including different sets of facial features, different amounts of contrast between foreground data of interest (e.g., a person's face) and background data, and so on.

In some examples, federated learning may be used to learn embeddings across a plurality of client devices. However, sharing embeddings of a model may not be appropriate, as the embeddings of a model may contain client-specific information. For example, the embeddings may expose data from which sensitive data used in the training process can be reconstructed. Thus, for machine learning models trained for security-sensitive applications or privacy-sensitive applications, such as biometric authentication or medical applications, sharing the embeddings of a model may expose data that can be used to break biometric authentication applications or to cause a loss of privacy in other sensitive data.

Accordingly, what is needed are improved techniques for training machine learning models using federated learning techniques.

### BRIEF SUMMARY

Certain aspects provide a method for training a machine learning model. The method generally includes receiving, at a device, optimization parameters, parameters of a machine learning model, and optimization state values to be updated based on a local data set. Parameters of the machine learning model and the optimization state values for the optimization parameters are updated based on the local data set. A peer device is selected to refine the machine learning model based on a graph data object comprising connections between the device and a plurality of peer devices, including the peer device. The updated parameters and the updated optimization state values are sent to the selected peer device for refinement by the selected peer device.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict certain aspects of the disclosure and are therefore not to be considered limiting of the scope of this disclosure.

FIG. 1 depicts an example environment in which a machine learning model is trained using a decentralized federated learning scheme and random walk traversal of a communication graph representing connections between client devices in the environment, according to aspects of the present disclosure.

FIG. 2 depicts example pseudocode for training a machine learning model using a decentralized federated learning scheme and random walk traversal of a communication graph representing connections between client devices in a computing environment, according to aspects of the present disclosure.

FIG. 3 depicts an example of a parallelized hyperparameter search and update process across participating devices in a federated learning scheme, according to aspects of the present disclosure.

FIG. 4 depicts example operations that may be performed by a client device for training a machine learning model, according to aspects of the present disclosure.

FIG. 5 depicts an example implementation of a processing system in which a machine learning model can be trained, according to aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatuses, methods, processing systems, and computer-readable mediums for training a machine learning model using a decentralized federated learning scheme and a communication graph illustrating connections between participating devices in a federated learning scheme.

In systems where a machine learning model is trained using federated learning, the machine learning model is generally defined based on model updates (e.g., changes in weights or other model parameters) generated by each of a plurality of participating client devices. Generally, each of these client devices may train a model using data stored locally on the client device. By doing so, the machine learning model may be trained using a wide variety of data, which may reduce the likelihood of the resulting global machine learning model underfitting data (e.g., resulting in a model that neither fits the training data nor generalizes to new data) or overfitting the data (e.g., resulting in a model that fits too closely to the training data such that new data is inaccurately generalized).

In many cases, training a machine learning model using federated learning may be controlled by a central server that coordinates the training process. In coordinating the training process, the central server may select a set of client devices to participate in updating the machine learning model, provide information about the current version of the machine learning model to the set of client devices, and receive and aggregate updates to the machine learning model from each client device in the set of client devices. Sharing information, such as embeddings, generated by each of the participating client devices when training the global machine learning model using federated learning, however, may compromise the security and privacy of data used to train the machine learning model on client devices. For example, because the embeddings generated by participating client devices are closely coupled with the data used to generate the embeddings, sharing the embeddings between different client devices or to a server coordinating the training of the machine learning model may expose sensitive data (e.g., in such a manner that the underlying data could be reconstructed, or at least substantially reconstructed, from an embedding representation of the underlying data). Thus, sharing the embeddings generated by a client device with other devices in a federated learning environment may create security risks (e.g., for biometric data used to train machine learning models deployed in biometric authentication systems) or may expose private data to unauthorized parties.

To mitigate privacy and security issues that may arise from sharing updates to a machine learning model with a central server, decentralized processes can be used to train a machine learning model using federated learning. In one example, participant client devices in a federated learning scheme can broadcast updates to the machine learning model to other participant client devices. Broadcasting updates to participant client devices in a federated learning scheme, however, may increase the communications overhead involved in a federated learning process. In another example, participant client devices can randomly select a peer device to update a model without adapting various optimization parameters for updating the model. However, updating a model in such a manner may result in a model with poor inference performance, as the resulting model may be overfit or underfit to the training data set and/or may otherwise inaccurately generate inferences for various inputs.

Aspects of the present disclosure provide techniques for training and updating machine learning models using decentralized federated learning techniques that improve security and privacy when sharing embedding data generated by client devices compared to conventional federated learning techniques, while also resulting in a model with good inference performance. To do so, a client device training a machine learning model uses a communication graph to randomly select the next peer client device (e.g., using a random walk procedure through the communication graph) that is to update a machine learning model. Various parameters and other information about the machine learning model, such as optimizer state data, may be provided to the selected client device to adapt a rate at which the machine learning model changes during each iteration of a federated learning process. By updating a machine learning model using decentralized federated learning techniques, aspects of the present disclosure can participate in a federated learning process without exposing information to potentially untrusted parties (e.g., a central server) about the underlying data set used to train the machine learning model. Thus, the security and privacy of the data in the underlying data set used to train the machine learning model may be preserved, which may improve the security and privacy of data used in training a machine learning model using federated learning techniques relative to federated learning approaches coordinated by a third party (e.g., the central server). Further, because each participating client device can receive optimizer state data that the client device can use to control the rate at which a machine learning model changes, aspects of the present disclosure may allow for a machine learning model with sufficient inference performance to be trained using decentralized federated learning techniques.

### Example Decentralized Federated Learning Architecture

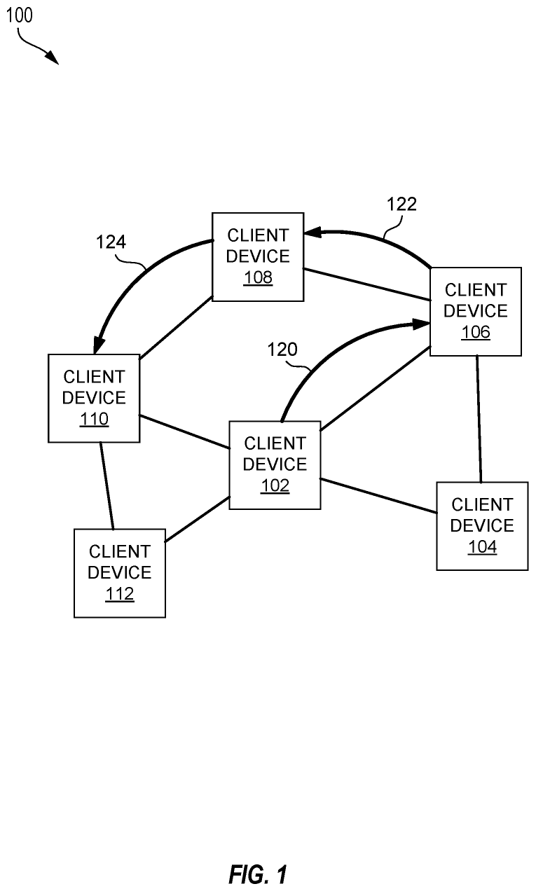

FIG. 1 depicts an example environment 100 in which machine learning models are trained by a plurality of client devices using decentralized federated learning techniques. As illustrated, environment 100 includes a plurality of client devices 102, 104, 106, 108, 110, and 112. While six client devices are illustrated in FIG. 1 for simplicity of illustration, it should be understood that environment 100 in which machine learning models are trained using decentralized federated learning techniques may include any number of client devices.

The plurality of client devices 102-112 may be designated as a pool S of client devices, where each client device s E S has access to a local data set [symbol] ₛ of Nₛ data points. To train a machine learning model using federated learning, a set of model parameters w may be learned according to the equation:

$${w}^{*} = arg {min}_{w ∈ {ℝ}^{d}} {𝔼}_{s \sim p ( s )} [ {𝔼}_{ξ \sim p ( {𝒟}_{s} )} [ f ( w , ξ ) ] ]$$

where p(s) represents a probability distribution,

$$p ( s ) = \frac{{N}_{s}}{N}$$

and f(w, ξ) represents a loss function computed on parameters w on a data sample ξ. The set of model parameters w* generally corresponds to an optimized w based on a uniform random sampling from a global data distribution over the data aggregated from the data sets [symbol] ₛ associated with the pool S of client devices 102-112. As discussed, in typical federated learning schemes, a central server or other coordinator can learn the set of model parameters w by exchanging information about model updates between client devices participating in a federated learning scheme and the central server, at the risk of leaking private or sensitive information to an unknown party.

To mitigate the risk of sharing private or sensitive information in a federated learning scheme, training of a machine learning model may be distributed amongst a group of client devices without the use of a central server or other coordinator to manage training of the machine learning model. To do so, the client devices 102-112 in environment 100 may be organized into a communications graph [symbol] with the pool S of client devices 102-112 connected by a set of communication links E. Generally, communications graph [symbol] may be a connected graph such that each client device in the communications graph is connected with at least one other client device in the communications graph. The communications graph may be a non-bipartite graph, which may allow for client devices to be indirectly connected to other client devices. For example, as illustrated, client device 102 may be directly connected with client devices 104, 106, 110, and 112, and may be indirectly connected with client device 108 (e.g., may be connected with client device 108 through either of client devices 106 or 110). Finally, the communications graph may be a symmetric graph in which connections between connected client devices are bidirectional (e.g., for a given pair of client devices A and B, client device A can send information about a machine learning model to client device B, and client device B can send information about a machine learning model to client device A).

Within this graph, each client device s has a set of neighbors [symbol] (s):={v∈S:(s, v)∈E} defined by the connections available to the client device s. For example, environment 100 may be illustrated as a graph with the following connections. Client device 102 is illustrated as having direct communications links with client devices 104, 106, 110, and 112 (e.g., client device 102 has neighboring client devices 104, 106, 110, and 112). Client device 104 is illustrated as having direct communications links with client devices 102 and 106. Client device 106 is illustrated as having direct communication links with client devices 102, 104, and 108. Client device 108 is illustrated as having direct communication links with client devices 106 and 110. Client device 110 is illustrated as having direct communication links with client devices 108, 112, and 102. Finally, client device 112 is illustrated as having direct communication links with client devices 110 and 102.

Generally, the client devices in the pool Sin the communications graph [symbol] may be a variety of devices, such as smartphones, Internet of Things (IoT) devices, or other computing devices which can communicate with each other and which may participate in a federated learning process. The connections between these devices may be based on physical networks, virtual networks, routing times, trust between owners of these devices, social network connections between owners of these devices, and the like

To train a machine learning model and learn the set of model parameters w in environment 100, the machine learning model may be trained based on a random walk through the communication graph representing environment 100. In a random walk procedure, a client device can randomly select a neighboring client device as the next device to train the machine learning model (e.g., update the parameters w based on local data at the selected client device). Parameters of the machine learning model, as well as other optimization settings and state variables (as discussed in further detail below) may be provided to the selected client device, and the selected client device can update the parameters of the machine learning model based on the optimization settings, state variables, and local data at the selected client device. After updating the machine learning model, the selected client device can determine whether to randomly select a neighboring client device to further update the model or to perform another update locally using the local data at the selected client device.

For example, as illustrated, an initial round of training (or updating) a machine learning model using a federated learning scheme may be executed at client device 102, which, as discussed above, has a set of neighbors [symbol] (102)={104,106,110,112}. When client device 102 determines that another client device in environment 100 should update the machine learning model based on the local data at another client device, client device 102 can thus randomly select one or more of client devices 104, 106, 110, or 112 to train (or update) the machine learning model. As illustrated, at stage 120, the client device 102 randomly selects client device 106 as the next client device to train (or update) the machine learning model. Similarly, after client device 106 trains (or updates) the machine learning model based on local data at client device 106, client device 106 selects a neighboring client device from the set of neighbors [symbol] (106)={102, 104, 108}. At stage 122, as illustrated, client device 106 selects client device 108 as the next client device to train (or update) the machine learning model. Finally, at stage 124, client device 108 selects client device 110 from the set of neighboring client devices [symbol] (108)={106, 110} as the next client device to train (or update) the machine learning model. In some aspects, a client device can monitor for acknowledgments or other information indicating that a selected next client device has received the information about the machine learning model and has commenced training (or updating) the machine learning model. If the client device does not receive an acknowledgment message within a threshold amount of time, then the client device can re-transmit the information about the machine learning model or re-select a neighboring client device to train (or update) the model. In some aspects, information about client device performance may be shared amongst the client devices 102-112 in environment 100. Generally, when multiple client devices determine that a given client device is nonperformant (e.g., nonresponsive, slow to respond, etc.), the information about that given client device may be published in environment 100 so that the given device is not considered a viable candidate for selection as the next client device to train (or update) the machine learning model)

In order to optimize the model parameters w, a random walk procedure over a communications graph [symbol] representing the client devices 102-112 in environment 100 may be defined such that the random walk procedure has a desired stationary distribution over the client devices 102-112 (e.g., such that

$$p ( s ) = \frac{{N}_{s}}{N}$$

By defining the random walk procedure over communications graph [symbol] such that

$$p ( s ) = \frac{{N}_{s}}{N} ,$$

a global loss function may be asymptotically optimized such that the global loss function asymptotically approaches a minimum value.

An adjacency matrix A∈{0, 1}^{N×N} may be defined that denotes the connectivity of the N client devices 102-112 according to communications graph [symbol] . If a node i is connected to node j, then Aᵢⱼ=Aⱼᵢ=1; otherwise, Aᵢⱼ=Aⱼᵢ=0. A transition matrix P may be defined as an N×N matrix between the N client devices in environment 100 (and thus, the N nodes in communications graph [symbol] ). In this transition matrix P, a transaction from a node j to a node i may be represented by the equation: Pᵢⱼ=p(i|j)=1/| [symbol] (j)|, where p(i|j) represents a probability distribution of selecting node i given a prior selection of node j for updating the machine learning model and | [symbol] (·)| returns the number of neighbors of a given node (e.g., the degree of the node in a communication graph [symbol] . Transition matrix P may thus be an inverse diagonal matrix D, where D includes the degrees of each node in the diagonal of the matrix.

In some aspects, a strategy used to select a neighboring client device (represented as a node in communications graph [symbol] ) to which updates are transmitted may be based on uniform random selection of a neighboring client device, represented by the equation P=AD⁻¹. Transitions from one client device to another client device may rely on local information (e.g., information about the other client devices with which a specific client device is connected). However, to enforce a stationary distribution over the client devices so that the global loss function of the machine learning model is asymptotically optimized, a Metropolis-Hastings adjustment of the probability distribution may be used to select a specific neighboring client device as the next client device to train (or update) a model. The Metropolis-Hastings adjustment of the probability distribution may be defined according to the equation:

$${\hat{P}}_{i j} = \{ \begin{matrix}{P}_{ij} min ( 1 , \frac{p ( i ) {P}_{ji}}{p ( j ) {P}_{ij}} ) , i \neq j \\ 1 - {\sum }_{k \neq j} {\hat{P}}_{kj} , i = j\end{matrix} \to {\hat{P}}_{ij} = \{ \begin{matrix}{P}_{ij} min ( 1 , \frac{{N}_{i} {P}_{ji}}{{N}_{j} {P}_{ij}} ) , i \neq j \\ 1 - {\sum }_{k \neq j} {\hat{P}}_{kj} , i = j\end{matrix}$$

Using the Metropolis-Hastings adjustment of the transition probability distribution may ensure that the stationary distribution remains equal to p(s) and may involve some data sharing between the client devices 102-112 in environment 100 which may be performed when a federated learning process is initiated.

In some aspects, to determine when to terminate a federated learning process to update the machine learning model, a client device can evaluate the inference performance of the machine learning model using a verification data set including test data and ground-truth inferences associated with the test data. If the inference performance of the machine learning model for the verification data set meets or exceeds a target set of metrics, such as a percentage of accurate or inaccurate inferences generated for the verification data set, then the client device can determine that the model is sufficiently trained and that compute resources need not be expended on further training (or updating) of the machine learning model. As such, the client device can propagate the parameters of the machine learning model through the communications graph so that each client device 102-112 in environment 100 has an up-to-date version of the machine learning model. Each of the receiving client devices can validate the performance of the machine learning model based on the propagated parameters, and based on determining that the performance of the machine learning model using the propagated parameters meets or exceeds a threshold performance level, the receiving client devices can determine that no further training is needed.

To further aid in training the machine learning model and generating a resulting model that has sufficient inference performance, various adaptive optimization techniques can be used in the decentralized federated learning scheme discussed herein. Generally, adaptive optimization techniques define two moments for each parameter in the machine learning model that correct for randomness in gradient direction that may be experienced during training of a machine learning model. The first moment may be an exponential moving average of a gradient, and the second moment may be an exponential moving average of a squared gradient. These moments may be used to adaptively increase or decrease the effective learning rate in response to gradient variation at each iteration of training the machine learning model in environment 100 (e.g., when the model is trained by a different client device 102-112 in environment 100).

Because training of a machine learning model in environment 100 is not controlled by a central server or other central coordinator, information about the moments may be shared along with the parameters of the machine learning model when a first client device instructs a second client device to train (or update) the machine learning model based on local data at the second client device. However, because this information may occupy a significant amount of space (e.g., may have the same bit size as the underlying data associated with each parameter) and thus increase the communications overhead involved in transferring information about a machine learning model from one client device to another client device. Thus, various techniques may be used to compress the moment data. For example, the first moment may be set to 0, which may reduce the amount of data transmitted between client devices and avoid the introduction of bias in the update direction that may occur due to compressing the first moment. The second moment may be compressed by quantizing the second moment into one of a plurality of quantized values. The second moment may be compressed using various techniques, including scalar quantization, factorization, relative entropy coding, or other techniques that may be appropriate quantizing the second moment into one of a plurality of quantized values.

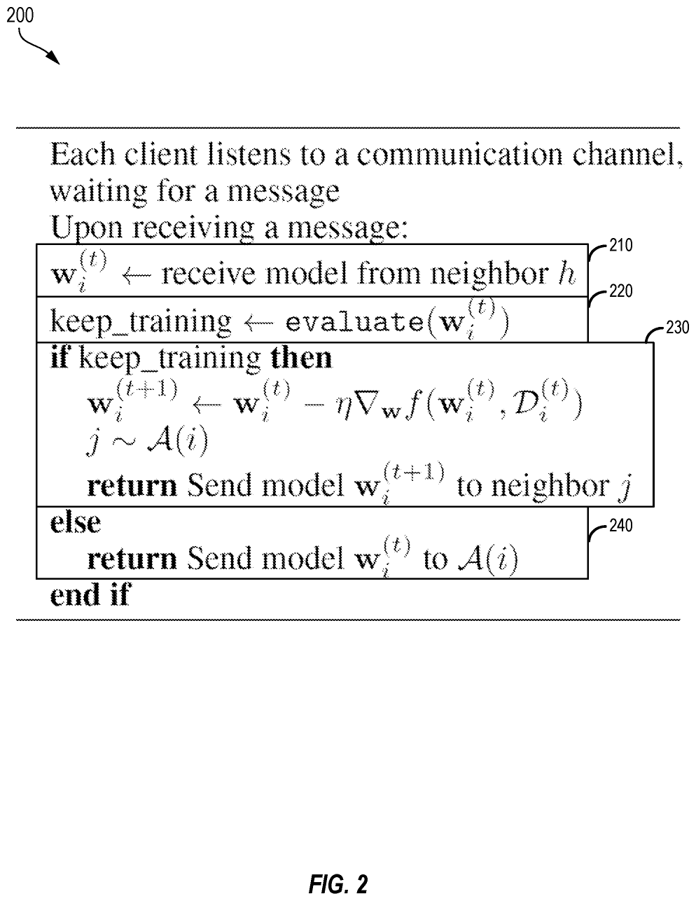

FIG. 2 depicts example pseudocode 200 for training a machine learning model using a decentralized federated learning scheme and random walk traversal of a communication graph representing connections between client devices in a computing environment, according to aspects of the present disclosure.

As illustrated in pseudocode 200, at block 210 client device i receives a model wᵢ^{(t)} from a neighboring client device in a computing environment, representing the state of the model at time t (e.g., after having been trained by the neighboring client device, as an initial state of the device, etc.).

At block 220, the client device i determines, based on an evaluation of the accuracy of model wᵢ^{(t)} on a validation data set at the client device i, whether to continue to train the model. If the accuracy of model wᵢ^{(t)} for the validation data set at client device i meets or exceeds a threshold accuracy level, then the client device can determine that further training may not be warranted and proceed to block 240. If, however, the accuracy of wᵢ^{(t)} for the validation data set at client device i does not meet the threshold accuracy level, then client device i can proceed to block 230.

At block 230, client device i generates an updated model wᵢ^{(t+1)} based on updates to the model generated based on local data [symbol] ᵢ. The updated model may be generated according to the expression:

$${w}_{i}^{( t + 1 )} ← {w}_{i}^{( t )} - η {∇}_{w} f ( {w}_{i}^{( t )} , {𝒟}_{i}^{( t )} )$$

where η represents the learning rate, or the rate at which updates are made to the model wᵢ^{(t)} and □_{w}f(wᵢ^{(t)}, [symbol] ᵢ^{(t)} represents a loss function which may be optimized in order to train the updated model wᵢ^{(t)}. A neighboring client device j may then be selected from the neighboring client devices [symbol] (i) for client device i, as discussed above, and the updated model wᵢ^{(t+1)} may be distributed to the selected neighboring client device j for evaluation and potentially for updating based on local data at the selected neighboring client device j.

If, however, at block 220, the client device i determines that inference accuracy for the model wᵢ^{(t)} meets or exceeds a threshold accuracy level, then at block 240, the client device i distributes the model wᵢ^{(t)} to the neighboring client devices [symbol] (i).

In some aspects, a client device can use various techniques to adaptively increase or decrease hyperparameters, such as the learning rate, in response to gradient variance across iterations of training the machine learning at different client devices participating in a distributed federated learning scheme. For example, the exponential moving average of gradients (also referred to as first moment data) and the exponential moving average of squared gradients (also referred to as second moment data) may be used by neighboring client devices to control updates to the machine learning model. To communicate information while reducing the overhead involved in communicating updates between client devices participating in a federated learning scheme, the first moment data may be dropped, and second moment data may be communicated with the updated model wᵢ^{(t+1)} to a neighboring client device.

At the neighboring client device, given an adjacency matrix A described above and a transition matrix P that respects the connectivity characteristics of the client devices as reflected in adjacency matrix A, the marginal distribution of a random walk over the client devices participating in a federated learning scheme may be represented by the equation:

$${π}_{t} = {P}^{t} {π}_{0}$$

where π₀ represents an initial distribution and π^{t} represents the stationary distribution of the random walk. Assuming that a matrix Q exists such that QPQ⁻¹ is a symmetric matrix having eigenvalues of 1=λ₁>λ₂≥ . . . >λ_{N}>−1, then the Euclidean space in which the model maps data may be represented according to the expression:

$$\vert {𝔼}_{{π}_{t}} [ f ] - {𝔼}_{{π}^{*}} [ f ] \vert \leq G \sqrt{N} {λ}^{t}$$

where |f|_{∞}≤G and λ=max(λ₂, |λ_{N}|). Further, it may be assumed that each total loss function ƒₛ is L-smooth (e.g., is a continuously differentiable function), gradients are upper bounded by a constant G, and for any dimension, the gradient variance at a client device s is upper-bounded by σᵢᵢ² for all client devices S and the global gradient variance is upper-bounded by σ_{gi·}²t. σ²=Σiσᵢ² and σᵢ²=Σᵢσᵢᵢ².

Convergence using the first moment data and second moment data may thus satisfy the expression:

$$𝔼 [ {‖ ∇ f ( {w}_{a} ) ‖}^{2} ] \leq O ( \frac{f ( {w}_{1} ) - f ( {w}^{*} )}{η T} + {σ}^{2} + \frac{λ \sqrt{N}}{( 1 - λ ) T} )$$

where w is a randomly chosen iteration between w₁ and w_{T}, and T represents the number of iterations over which the machine learning model is updated.

Thus, an asymptotic bound achieved by training a machine learning model using the decentralized federated learning scheme and random walk traversal discussed herein may be similar to that achieved using adaptive optimization in a centralized environment, with the addition of an error term from decentralization that may decrease linearly as the number of iterations T increases.

In some aspects, to further reduce the communications overhead in training a machine learning model using a decentralized federated learning scheme and a random walk traversal of a communication graph, the second moment data may be quantized (e.g., in the log domain). Quantization may be performed such that a single bit is used to demote whether the second moment is a zeroed or non-zero value and the remaining b−1 bits (for a b-bit quantization of the second moment data) are used for the quantized value of the second moment data, such that the minimum and maximum values of the logarithm of the second moment data are represented exactly so that data is not clipped. In such a case, the updates to the machine learning model generated by participating client devices may satisfy the expression:

$$𝔼 [ {‖ ∇ f ( {w}_{a} ) ‖}^{2} ] \leq 𝒪 ( \frac{f ( {w}_{1} ) - f ( {w}^{*} )}{η T} + {σ}^{2} + q + \frac{\sqrt{N} λ}{( 1 - λ ) T} )$$

where w is a randomly chosen iteration between w₁ and w_{T}, and T represents the number of iterations over which the machine learning model is updated.

For a number of updates K performed by a client device before distributing the model to a neighboring client device, it may be assumed that for any given point w∈ [symbol] \hat{ }D a constant ξ² exists that defines the upper bound of the distance (e.g., an L2 distance between vectors) between the gradient on any given client s and the global gradient, according to the expression:

$${‖ ∇ {f}_{s} ( w ) - ∇ f ( w ) ‖}_{2}^{2} \leq {ζ}^{2}$$

Assuming that the learning rate parameter η and error ϵ for the machine learning model is selected such that:

$$\frac{2 L η}{ϵ} \leq \frac{1}{2} , \frac{2 G \sqrt{1 - {β}_{2}}}{ϵ} \leq \frac{1}{4}$$

the updates to the machine learning model based on quantized second moment data may satisfy the expression:

$$𝔼 [ {‖ ∇ f ( {w}_{a} ) ‖}^{2} ] \leq 𝒪 ( \frac{f ( {w}_{1} ) - f ( {w}^{*} )}{η T} + \frac{{σ}^{2}}{K} + q + \frac{K - 1}{K} ( {σ}_{l}^{2} + ζ + {ζ}^{2} ) + \frac{λ \sqrt{N}}{( 1 - λ ) T} )$$

Thus, by using second moment data and quantizing such data in training a machine learning model, for a number of updates K performed by a client device, it can be seen that a machine learning model may be trained by trading total variance σ² for local gradient variance σₗ² and bias ξ. Thus, aspects of the present disclosure may allow for accurate models to be trained using distributed federated learning techniques when the data used by each client device are independent and identically distributed random variables, the bias term is a small term, and multiple updates K are performed at each client device prior to distributing the machine learning model to a neighboring client device.

### Example Parallelized Hyperparameter Search

Because a machine learning model may be trained by many devices in a distributed environment without depending on completion of a training process by other devices in the distributed environment, and because no single device may be a bottleneck for training a machine learning model, aspects of the present disclosure may allow for hyperparameters of a machine learning model to be identified in parallel.

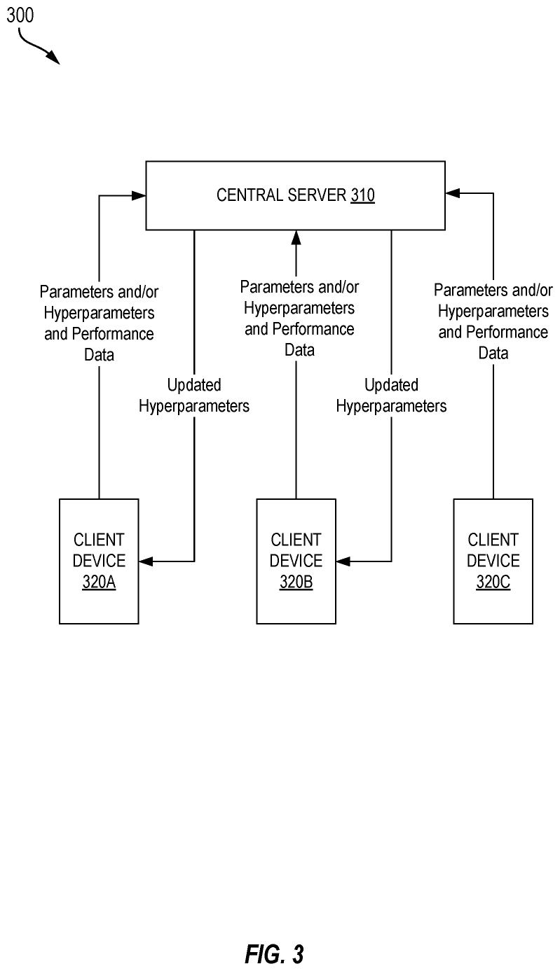

FIG. 3 illustrates an example 300 of a parallelized hyperparameter search and update process across participating client devices in a federated learning scheme, according to aspects of the present disclosure. As illustrated, a plurality of client devices 320A-320C (which may be representative of client devices 102-112 illustrated in FIG. 1) train a machine learning model using different hyperparameters and report information about the hyperparameters and the performance of the machine learning model to a central server 310. This central server 310 generally need not play a role in controlling or coordinating training of the machine learning model by the client devices 320A-320C, such that further training of a machine learning model (as discussed above with respect to FIG. 1) may be performed in a decentralized manner and thus preserve the privacy and security of training data at the participating client devices 320A-320C (and other client devices not illustrated in FIG. 3 that are also participating in the federated learning scheme).

In executing a parallelized hyperparameter search and update process, client devices 320A-320C may be reached by other client devices (not illustrated) via different random walks through a communications graph g with different optimization parameters and machine learning model hyperparameters. It should be noted that in reaching these client devices 320A-320C, there may be no dependency relationships between the different paths through the communications graph g by which these client devices are reached, and the client devices in the environment need not be synchronized. Thus, non-performant (or slow) client devices may be bypassed. Further, the performance of many versions of a machine learning model may be evaluated with little to no additional computational expense within the environment 100.

Generally, each client device 320A-320C may train (or update) a machine learning model using a set of optimization parameters and hyperparameters. These parameters or hyperparameters may include, for example, model architecture information (e.g., a number of layers in a neural network, types of layers in the neural network, numbers of hidden units in the neural network, etc.), learning rate, training batch size, and the like. After training the machine learning model, each client device 320A-320C can validate the performance of its respective updated machine learning model based on a validation data set. As discussed, the performance of a machine learning model may be defined based on inference accuracy for the machine learning model (e.g., the percentage of correct inferences generated for a validation data set, the percentage of incorrect inferences generated for the validation data set, etc.). The hyperparameters of the machine learning model and/or other parameters of the machine learning model (e.g., weights), and performance information associated with these hyperparameters and/or other parameters.

Generally, central server 310 may provide a virtual blackboard that allows the client devices 320A-320C (and other client devices participating in a decentralized federated learning scheme or otherwise using a model generated using the decentralized federated learning scheme as discussed herein) to read and write performance data and model hyperparameter and/or other parameter data. If a client device determines that the performance data written to central server 310 by another client device is associated with better inference performance, then the client device can retrieve the hyperparameters and/or other machine learning model parameters from the central server 310 and apply those parameters to the training the local version of the machine learning model.

For example, as illustrated in FIG. 3, client devices 320A, 320B, and 320C post or otherwise write information about the hyperparameters and/or other machine learning model parameters to central server 310 for other devices to examine. In some aspects, client devices 320A, 320B, and 320C may write this information after validating that the performance of the machine learning model trained at each of these client devices meets or exceeds a threshold performance level (e.g., inference accuracy, etc.). Client devices 320A and 320B can examine the posted performance data and determine that the performance of a machine learning model with the hyperparameters and/or other parameters generated by client device 320C exceeds the performance of the machine learning models trained by client devices 320A and 320B. Thus, client devices 320A and 320B retrieve the parameters generated by client device 320C and implement these hyperparameters and/or other parameters for subsequent operations (e.g., training and/or inference).

### Example Methods for Training Machine Learning Models Using Decentralized Federated Learning Techniques

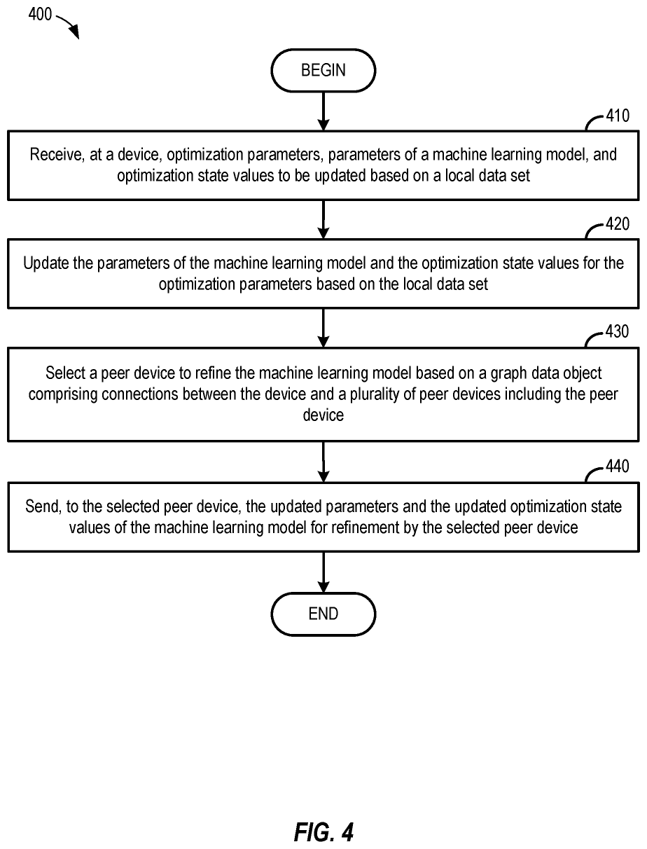

FIG. 4 illustrates example operations 400 that may be performed for training a machine learning model, according to certain aspects of the present disclosure. Operations 400 may be performed, for example, by a device participating in a decentralized federated learning scheme to train a machine learning model using local data, such as a cell phone, a tablet computer, a laptop computer, or other computing device that can participate in a distributed federated learning scheme.

As illustrated, operations 400 begin at block 410 with receiving, at a device, optimization parameters and parameters of a machine learning model and optimization state values to be updated based on a local data set.

In some aspects, the optimization state values include one or more state variables that control an amount by which a peer device adjusts the updated parameters of the machine learning model. These state variables may include, for example, an exponential moving average associated with each parameter in the machine learning model and an exponential moving average of a square of the gradient associated with each parameter in the machine learning model. In some aspects, the one or more state variables may include a quantized value for at least one of the state variables. For example, as discussed, the exponential moving average of the gradient may be zeroed, and the exponential moving average of the square of the gradient may be quantized into one of a plurality of categories having a smaller bit size than a bit size of the underlying parameter for which the exponential moving average of the square of the gradient is calculated.

At block 420, operations 400 proceed with updating the parameters of the machine learning model and the optimization state values for the optimization parameters based on the local data set.

At block 430, operations 400 proceed with selecting a peer device to refine the machine learning model based on a graph data object comprising connections between the device and a plurality of peer devices, including the peer device.

In some aspects, the graph data object may be a connectivity graph that includes network connections between the device and the plurality of peer devices. In some aspects, the graph data object may include social connections between a user of the device and users associated with the plurality of peer devices. In some aspects, the graph data object may be generated based on routing times between the device and the plurality of peer devices, physical proximity between the device and the plurality of peer devices, or other information identifying relationships between the device and the plurality of peer devices.

In some aspects, selecting the peer device may include selecting a device from the plurality of peer devices based on random selection of devices in the graph data object having a connection to the device. In doing so, a random walk may be performed through the graph data object. As discussed above, in some aspects, selection of the peer device from the plurality of peer devices may be performed to asymptotically optimize a global loss function based on a stationary distribution p(s)=.

$$p ( s ) = \frac{{N}_{s}}{N} .$$

In some aspects, selecting the peer device to refine the machine learning model may be performed based on validating the performance of the updated machine learning model based a validation data set. If the performance of the updated machine learning model meets or exceeds a threshold performance metric, then the device can determine that the model can be further trained by a peer device and can select the peer device to use in training the model. Otherwise, the device can perform additional rounds of training on the machine learning model (e.g., using different local data sets) to further refine the machine learning model before selecting a peer device to use for further training of the machine learning model.

At block 440, operations 400 proceed with sending, to the selected peer device, the updated parameters of the machine learning model and the updated optimization state values for refinement by the selected peer device.

In some aspects, the device can validate the performance of the updated machine learning model based on a validation data set. Information associated with the performance of the updated machine learning model and the parameters of the machine learning model may be published to a central server. In some aspects, the device can identify, based on performance information published on the central server, second parameters different from the published parameters and resulting in a machine learning model with improved performance characteristics relative to the updated machine learning model. Based on identifying these parameters that result in a machine learning model with improved performance characteristics relative to the updated machine learning model, the device can update the local version of the machine learning model based on the second parameters. The second parameter may, for example, include hyperparameters for training the machine learning model and/or other parameters characterizing the machine learning model (e.g., weights, etc.).

In some aspects, the device can validate the performance of the updated machine learning model based on a validation data set. If it is determined that the performance of the updated machine learning model meets a threshold performance level, then the device can distribute the updated machine learning model to one or more peer devices in the graph data object.

### Example Processing Systems for Training Machine Learning Models Using Decentralized Federated Learning Techniques

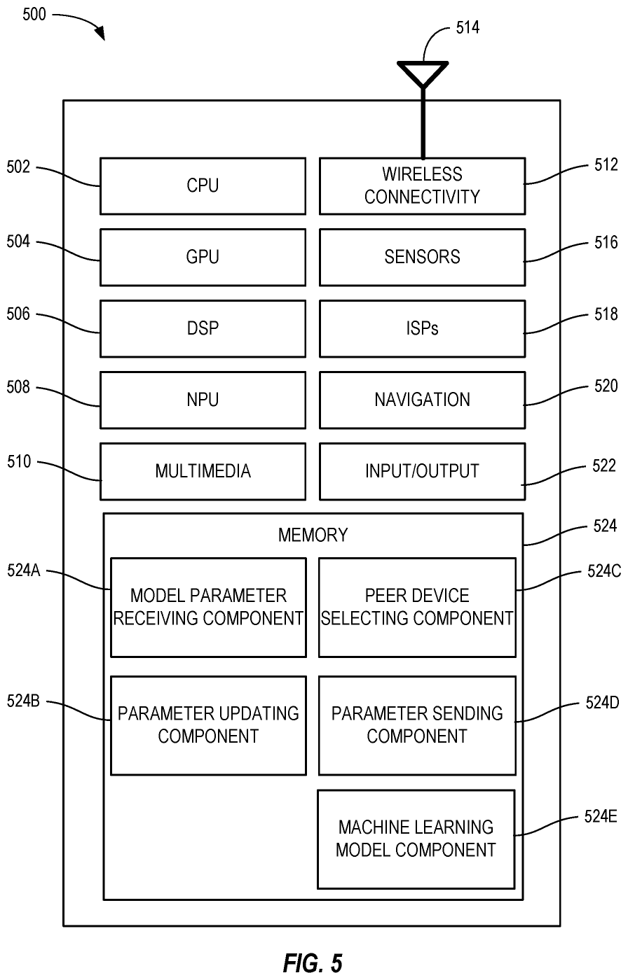

FIG. 5 depicts an example processing system 500 for training a machine learning model using decentralized federated learning techniques, such as described herein for example with respect to FIG. 4.

Processing system 500 includes a central processing unit (CPU) 502, which in some examples may be a multi-core CPU. Instructions executed at the CPU 502 may be loaded, for example, from a program memory associated with the CPU 502 or may be loaded from a memory partition (e.g., of memory 524).

Processing system 500 also includes additional processing components tailored to specific functions, such as a graphics processing unit (GPU) 504, a digital signal processor (DSP) 506, a neural processing unit (NPU) 508, a multimedia processing unit 510, a wireless connectivity component 512.

An NPU, such as NPU 508, is generally a specialized circuit configured for implementing control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as NPU 508, are configured to accelerate the performance of common machine learning tasks, such as image classification, machine translation, object detection, and various other predictive models. In some examples, a plurality of NPUs may be instantiated on a single chip, such as a system on a chip (SoC), while in other examples such NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this new piece through an already trained model to generate a model output (e.g., an inference).

In some implementations, NPU 508 is a part of one or more of CPU 502, GPU 504, and/or DSP 506. These may be located on a user equipment (UE) in a wireless communication system or another computing device.

In some examples, wireless connectivity component 512 may include subcomponents, for example, for third generation (3G) connectivity, fourth generation (4G) connectivity (e.g., 4G LTE), fifth generation connectivity (e.g., 5G or NR), Wi-Fi connectivity, Bluetooth connectivity, and other wireless data transmission standards. Wireless connectivity component 512 is further connected to one or more antennas 514.

Processing system 500 may also include one or more sensors processing units 516 associated with any manner of sensor, one or more image signal processors (ISPs) 518 associated with any manner of image sensor, and/or a navigation component 520, which may include satellite-based positioning system components (e.g., GPS or GLONASS) as well as inertial positioning system components.

Processing system 500 may also include one or more input and/or output devices 522, such as screens, touch-sensitive surfaces (including touch-sensitive displays), physical buttons, speakers, microphones, and the like.

In some examples, one or more of the processors of processing system 500 may be based on an ARM or RISC-V instruction set.

Processing system 500 also includes memory 524, which is representative of one or more static and/or dynamic memories, such as a dynamic random access memory, a flash-based static memory, and the like. In this example, memory 524 includes computer-executable components, which may be executed by one or more of the aforementioned processors of processing system 500.

In particular, in this example, memory 524 includes model parameter receiving component 524A, parameter updating component 524B, peer device selecting component 524C, parameter sending component 524D, and machine learning model component 524E. The depicted components, and others not depicted, may be configured to perform various aspects of the methods described herein.

Generally, processing system 500 and/or components thereof may be configured to perform the methods described herein, including operations 400 of FIG. 4.

Notably, in other aspects, elements of processing system 500 may be omitted, such as where processing system 500 is a server computer or the like. For example, multimedia component 510, wireless connectivity component 512, sensor processing units 516, ISPs 518, and/or navigation component 520 may be omitted in other aspects. Further, elements of processing system 500 may be distributed, such as training a model and using the model to generate inferences.

### Example Clauses

Implementation details of various aspects of the present disclosure are described in the following numbered clauses.

Clause 1: A computer-implemented method, comprising: receiving, at a device, optimization parameters, parameters of a machine learning model, and optimization state values to be updated based on a local data set; updating the parameters of the machine learning model and the optimization state values based on the local data set; selecting a peer device to refine the machine learning model based on a graph data object comprising connections between the device and a plurality of peer devices, including the peer device; and sending, to the selected peer device, the updated parameters of the machine learning model and the updated optimization state values for refinement by the selected peer device.

Clause 2: The method of Clause 1, wherein the optimization state values comprise one or more state variables controlling an amount by which the selected peer device adjusts the updated parameters of the machine learning model.

Clause 3: The method of Clause 2, wherein the one or more state variables comprise an exponential moving average of a gradient associated with each parameter in the machine learning model and an exponential moving average of a square of the gradient associated with each parameter in the machine learning model.

Clause 4: The method of Clause 2 or 3, wherein the one or more state variables comprise a quantized value for at least one of the state variables.

Clause 5: The method of any of Clauses 1 through 4, wherein selecting the peer device comprises selecting a device from the plurality of peer devices based on random selection of devices in the graph data object having a connection to the device.

Clause 6: The method of any of Clauses 1 through 5, further comprising validating, by the device, performance of the machine learning model using the updated parameters based on a validation data set, wherein selecting the peer device is based on validating that the performance of the machine learning model using the updated parameters meets a threshold performance metric.

Clause 7: The method of any of Clauses 1 through 6, further comprising: validating, by the device, performance of the machine learning model using the updated parameters based on a validation data set; and publishing information associated with the performance of the machine learning model using the updated parameters and parameters of the machine learning model to a central server.

Clause 8: The method of Clause 7, further comprising: identifying, based on performance information published on the central server, second parameters different from the published parameters and resulting in a machine learning model with improved performance characteristics relative to the machine learning model using the updated parameters; and updating the machine learning model based on the second parameters.

Clause 9: The method of Clause 8, wherein the second parameters comprise one or more hyperparameters for training the machine learning model.

Clause 10: The method of any of Clauses 1 through 9, further comprising: validating, by the device, performance of the machine learning model using the updated parameters based on a validation data set; determining that the performance of the machine learning model using the updated parameters meets a threshold performance level; and distributing the updated parameters of the machine learning model to one or more peer devices in the graph data object based on the determining that the performance level of the updated machine learning model meets a threshold performance level.

Clause 11: The method of any of Clauses 1 through 10, wherein the graph data object comprising connections between the device and the plurality of peer devices includes network connections between the device and the plurality of peer devices.

Clause 12: The method of any of Clauses 1 through 11, wherein the graph data object comprising connections between the device and the plurality of peer devices includes social connections between a user of the device and users associated with the plurality of peer devices.

Clause 13: An apparatus comprising: a memory having executable instructions stored thereon; and a processor configured to execute the executable instructions to cause the apparatus to perform a method in accordance with any of Clauses 1 through 12.

Clause 14: An apparatus comprising means for performing a method in accordance with any of Clauses 1 through 12.

Clause 15: A non-transitory computer-readable medium having instructions stored thereon which, when executed by a processor, perform a method in accordance with any of Clauses 1 through 12.

Clause 16: A computer program product embodied on a computer-readable storage medium comprising code for performing a method in accordance with any of Clauses 1 through 12.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A computer-implemented method, comprising:
receiving, at a device, optimization parameters, parameters of a machine learning model, and optimization state values to be updated based on a local data set;
updating the parameters of the machine learning model and the optimization state values for the optimization parameters based on the local data set;
selecting a peer device to refine the machine learning model based on a graph data object comprising connections between the device and a plurality of peer devices, including the peer device; and
sending, to the selected peer device, the updated parameters of the machine learning model and the updated optimization state values for refinement by the selected peer device.

2. The method of claim 1, wherein the optimization state values comprise one or more state variables controlling an amount by which the selected peer device adjusts the updated parameters of the machine learning model.

3. The method of claim 2, wherein the one or more state variables comprise an exponential moving average of a gradient associated with each parameter in the machine learning model and an exponential moving average of a square of the gradient associated with each parameter in the machine learning model.

4. The method of claim 2, wherein the one or more state variables comprise a quantized value for at least one of the state variables.

5. The method of claim 1, wherein selecting the peer device comprises selecting a device from the plurality of peer devices based on random selection of devices in the graph data object having a connection to the device.

6. The method of claim 1, further comprising validating, by the device, performance of the machine learning model using the updated parameters based on a validation data set, wherein selecting the peer device is based on validating that the performance of the machine learning model using the updated parameters meets a threshold performance metric.

7. The method of claim 1, further comprising:
validating, by the device, performance of the machine learning model using the updated parameters based on a validation data set; and
publishing (1) information associated with the performance of the machine learning model using the updated parameters and (2) parameters of the machine learning model to a central server.

8. The method of claim 7, further comprising:
identifying, based on performance information published on the central server, second parameters different from the published parameters and resulting in a machine learning model with improved performance characteristics relative to the machine learning model using the updated parameters; and
updating the machine learning model based on the second parameters.

9. The method of claim 8, wherein the second parameters comprise one or more hyperparameters for training the machine learning model.

10. The method of claim 1, further comprising:
validating, by the device, performance of the machine learning model using the updated parameters based on a validation data set;
determining that the performance of the machine learning model using the updated parameters meets a threshold performance level; and
distributing the updated parameters of the machine learning model to one or more peer devices in the graph data object based on the determining that the performance level of the machine learning model using the updated parameters meets a threshold performance level.

11. The method of claim 1, wherein the graph data object comprising connections between the device and the plurality of peer devices includes network connections between the device and the plurality of peer devices.

12. The method of claim 1, wherein the graph data object comprising connections between the device and the plurality of peer devices includes social connections between a user of the device and users associated with the plurality of peer devices.

13. A system, comprising:
a memory having executable instructions stored thereon; and
at least one processor configured to execute the executable instructions to cause the system to:
receive, at the system, optimization parameters, parameters of a machine learning model, and optimization state values to be updated based on a local data set;
update the parameters of the machine learning model and the optimization state values for the optimization parameters based on the local data set;
select a peer device to refine the machine learning model based on a graph data object comprising connections between the system and a plurality of peer devices, including the peer device; and
send, to the selected peer device, the updated parameters of the machine learning model and the updated optimization state values for refinement by the selected peer device.

14. The system of claim 13, wherein the optimization state values comprise one or more state variables controlling an amount by which the selected peer device adjusts the updated parameters of the machine learning model.

15. The system of claim 14, wherein the one or more state variables comprise an exponential moving average of a gradient associated with each parameter in the machine learning model and an exponential moving average of a square of the gradient associated with each parameter in the machine learning model.

16. The system of claim 14, wherein the one or more state variables comprise a quantized value for at least one of the state variables.

17. The system of claim 13, wherein in order to select the peer device, the processor is configured to cause the system to select a peer device from the plurality of peer devices based on a random selection of devices in the graph data object having a connection to the system.

18. The system of claim 13, wherein the processor is further configured to cause the system to validate performance of the machine learning model using the updated parameters based on a validation data set, wherein selecting the peer device is based on validating that the performance of the machine learning model using the updated parameters meets a threshold performance metric.

19. The system of claim 13, wherein the processor is further configured to cause the system to:
validate performance of the machine learning model using the updated parameters based on a validation data set; and
publish (1) information associated with the performance of the machine learning model using the updated parameters and (2) parameters of the machine learning model to a central server.

20. The system of claim 19, wherein the processor is further configured to cause the system to:
identify, based on performance information published on the central server, second parameters different from the published parameters and resulting in a machine learning model with improved performance characteristics relative to the machine learning model using the updated parameters; and
update the machine learning model based on the second parameters.

21. The system of claim 20, wherein the second parameters comprise one or more hyperparameters for training the machine learning model.

22. The system of claim 13, wherein the processor is further configured to cause the system to:
validate performance of the machine learning model using the updated parameters based on a validation data set;
determine that the performance of the machine learning model using the updated parameters meets a threshold performance level; and
distribute the updated parameters of the machine learning model to one or more peer devices in the graph data object based on the determining that the performance level of the machine learning model using the updated parameters meets a threshold performance level.

23. The system of claim 13, wherein the graph data object comprising connections between the system and the plurality of peer devices includes network connections between the system and the plurality of peer devices.

24. The system of claim 13, wherein the graph data object comprising connections between the system and the plurality of peer devices includes social connections between a user of the system and users associated with the plurality of peer devices.

25. A system, comprising:
means for receiving, at a device, optimization parameters, parameters of a machine learning model, and optimization state values to be updated based on a local data set;
means for updating the parameters of the machine learning model and the optimization state values for the optimization parameters based on the local data set;
means for selecting a peer device to refine the machine learning model based on a graph data object comprising connections between the system and a plurality of peer devices, including the peer device; and
means for sending, to the selected peer device, the updated parameters of the machine learning model and the updated optimization state values for refinement by the selected peer device.

26. A computer-readable medium having executable instructions stored thereon which, when executed by a processor, perform an operation comprising:
receiving, at a device, optimization parameters, parameters of a machine learning model, and optimization state values to be updated based on a local data set;
updating the parameters of the machine learning model and the optimization state values for the optimization parameters based on the local data set;
selecting a peer device to refine the machine learning model based on a graph data object comprising connections between the system and a plurality of peer devices, including the peer device; and
sending, to the selected peer device, the updated parameters of the machine learning model and the updated optimization state values for refinement by the selected peer device.
